(19) United States
(12) Patent Application Publication
(10) Pub. No.: US 2013/0057573 A1
(43) Pub. Date: Mar. 7, 2013

(54) Smart Display with Dynamic Face-Based User Preference Settings

(71) Applicants: Hari Chakravarthula, San Jose, CA (US); Tomaso Paoletti, San Mateo, CA (US); Avinash Uppuluri, Sunnyvale, CA (US)

(72) Inventors: Hari Chakravarthula, San Jose, CA (US); Tomaso Paoletti, San Mateo, CA (US); Avinash Uppuluri, Sunnyvale, CA (US)

(73) Assignee: DigitalOptics Corporation Europe Limited, Galway (IE)

(21) Appl. No.: 13/294,964

(22) Filed: Nov. 11, 2011

Related U.S. Application Data
(60) Provisional application No. 61/530,867, filed on Sep. 2, 2011.

(51) Int. Cl. G09G 5/08; G09G 5/00

(52) U.S. Cl. 345/619; 345/158

(57) ABSTRACT

An electronic display is provided that can include any number of features. In some embodiments, the display includes sensors, such as a camera, configured to detect a user parameter of a user positioned before the display. The user parameter can be, for example, an age of the user, a distance of the user from the screen, a head angle of the user, a time the user has been positioned before the display, or an ambient light level. The display can include a processor configured to adjust a user preference or display an indicator to the user based on the detected user parameter.

### CROSS REFERENCE TO RELATED APPLICATIONS

This application claims the benefit under 35 U.S.C. 119 of U.S. Provisional Patent Application No. 61/530,867, filed Sep. 2, 2011, titled “Smart Display with Dynamic Face-Based User Preference Settings”.

This application is related to U.S. application Ser. No. 13/035,907, filed on Feb. 25, 2011, and co-pending U.S. application filed on the same day as this application, titled “Smart Display with Dynamic Font Management”.

### INCORPORATION BY REFERENCE

All publications and patent applications mentioned in this specification are herein incorporated by reference to the same extent as if each individual publication or patent application was specifically and individually indicated to be incorporated by reference.

### FIELD

This disclosure relates generally to display devices. More specifically, this disclosure relates to computing displays or television monitors.

### BACKGROUND

Electronic display devices are commonly used as television sets or with computers to display two-dimensional images to a user. In the case of computing, electronic display devices provide a visual interaction with the operating system of the computer.

In most cases, a user provides input to a computer with the use of an external input device, most commonly with the combination of a keyboard and a mouse or trackball. However, more recently, touchscreen devices (e.g., capacitive or resistive touchscreens) built into electronic displays have gained popularity as an alternative means for providing input to a computing device or television display.

Electronic displays have evolved from large, heavy cathode ray tube monitors (CRT) to lighter, thinner liquid crystal displays (LCD) and organic light emitting diode (OLED) displays. Many displays now incorporate additional features, such as cameras and universal serial bus (USB) ports, to improve the computing or television experience.

### SUMMARY OF THE DISCLOSURE

A method of dynamically changing a display parameter is provided, comprising detecting a user parameter of a user positioned before an electronic display, and automatically adjusting a user preference on the display or displaying an indicator based on the detected user parameter.

In some embodiments, the user parameter is an age of the user.

In another embodiment, an amount of displayable content is increased when the user is elderly. In another embodiment, an amount of displayable content is decreased when the user is a child or young adult.

In some embodiments, privacy settings are increased when the user is a child or young adult. In other embodiments, privacy settings are decreased when the user is an adult or elderly.

In some embodiments, the user parameter is a distance from the user to the electronic display. In one embodiment, a distance indicator is displayed when the distance is less than an optimal distance.

In one embodiment, the user parameter is a time the user has been positioned before the display. In some embodiments, a time indicator is displayed when the time is greater than a predetermined time limit.

In one embodiment, the user parameter is a head angle. In some embodiments, an ergonomic indicator is displayed when the head angle is improper.

In some embodiments, the user parameter is an ambient light level. In other embodiments, the user parameter is an ambient light level and a pupil closure percentage.

In one embodiment, if the ambient light level is low, and the pupil closure percentage is high, the display is automatically brightened. In another embodiment, if the ambient light level is low, and the pupil closure percentage is low, the display is automatically dimmed. In alternative embodiments, if the ambient light level is high, and the pupil closure percentage is high, the display is automatically brightened. In yet another embodiment, if the ambient light level is high, and the pupil closure percentage is low, the display is automatically dimmed.

The method of claim 13 wherein the display is automatically dimmed or brightened based on the detected ambient light level.

In some embodiments, the user parameter is an unknown user.

In one embodiment, the display is dimmed or turned off when the unknown user is detected. In another embodiment, the display is locked and a security indicator is shown on the display when the unknown user is detected. In some embodiments, the security indicator notifies the unknown user that access to the display is denied.

In some embodiments, the detecting step comprises detecting the user parameter with a sensor disposed on or near the electronic display. In one embodiment, the sensor comprises a camera.

In some embodiments, the electronic display comprises a computer monitor. In other embodiments, the electronic display comprises a cellular telephone.

In one embodiment, the automatically adjusting step comprises processing the user parameter with a controller and automatically adjusting the user preference on the display or displaying the indicator based on the detected user parameter.

An electronic display is also provided comprising sensors configured to detect a user parameter of a user positioned before the display, a screen configured to display text or images to the user, and a processor configured to adjust a user preference or display an indicator based on the detected user parameter.

In one embodiment, the user parameter is age.

In another embodiment, the user parameter is a distance from the user to the electronic display.

In some embodiments, the user parameter is a head angle of the user.

In one embodiment, the user parameter is an unknown user.

In some embodiments, the user parameter is an ambient light level

In some embodiments, the sensor comprises a camera.

In one embodiment, the electronic display comprises a computer monitor.

In another embodiment, the electronic display comprises a cellular telephone.

In some embodiments, the electronic display comprises a tablet computer.

A method of dynamically adjusting a display parameter is provided, comprising determining with a sensor whether a user's face is positioned before an electronic display, if the user's face is not positioned before the electronic display, monitoring for the user's face with the sensor for a predetermined period of time, and initiating a power savings routine on the electronic display if the user's face is not positioned before the electronic display during the predetermined period of time.

In some embodiments, the power savings routine comprises dimming the display.

In other embodiments, the power savings routine comprises powering off the display.

In some embodiments, after powering off the display, the method comprises occasionally powering on the sensor of the electronic display to monitor for the user's anatomy.

Some embodiments of the method further comprise determining with the sensor if the user's eyes are gazing towards the electronic display, if the user's eyes are not gazing towards the electronic display, monitoring with the sensor for the user's eyes to gaze towards the display during the predetermined period of time, and initiating the power savings routine on the electronic display if the user's eyes do not gaze towards the electronic display during the predetermined period of time.

In some embodiments, the predetermined period of time is user adjustable.

In other embodiments, a dimming percentage is user adjustable.

An electronic display is provided, comprising a sensor configured to detect a user's face positioned before the display, and a processor configured to implement a power savings routine if the user's face is not positioned before the display during a predetermined period of time.

In one embodiment, the sensor comprises a camera.

In other embodiments, the electronic display comprises a computer monitor.

In some embodiments, the electronic display comprises a cellular telephone.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is an illustration of a user in the field of view of a display.

FIG. 2 is an illustration of a child user in the field of view of a display.

FIGS. 3A-3B are illustrations of different users in the field of view of a display.

FIG. 4 is an illustration of a user in the field of view of a display with a user timer.

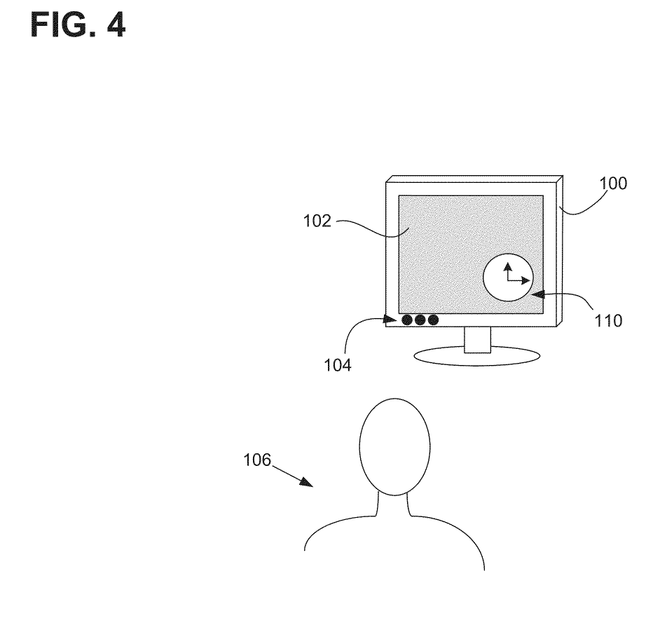

FIG. 5 illustrates an ergonomic indicator to a user in the field of view of a display.

FIG. 6 is an illustration of a privacy setting when two users are detected in the field of view of a display.

FIG. 7 illustrates an indicator when a user is not recognized by a display.

FIG. 8 illustrates a display that illuminates only a section of the display corresponding to a user's gaze.

FIG. 9 illustrates a distance indicator to a user in the field of view of the display.

### DETAILED DESCRIPTION

Techniques and methods are provided to adjust user preference settings based on parameters or conditions detected by an electronic display system or monitor. In some embodiments, the display system can detect and/or determine an age of a user. In another embodiment, the display system can detect and/or determine a distance between the user and the display. In yet another embodiment, the display system can detect and/or determine ambient light or the amount of light on a face of the user, either alone or in combination with the age or distance conditions detected above. In some embodiments, the display system can recognize a user's face, and can additionally recognize a user's gaze or determine the pupil diameter of the user.

Any number of user preferences or display settings can be dynamically adjusted based on the parameter or condition detected or determined by the display. For example, in one embodiment, displayable content or user privacy settings can be adjusted based on the detected age of the user. In another embodiment, the type of content or files able to be displayed can be limited based on the detected age of the user. In some embodiments, specific users are recognized individually, and displayable content and/or privacy settings can be individually tailored to the specific individual recognized by the display. In some embodiments, a user timer can determine when a predetermined time limit has been surpassed, and indicate to the user to discontinue use of the display. Additionally, the display can indicate to the user when the user is sitting or tilting in a way that can cause injury, pain, or discomfort. In some embodiments, the brightness of the screen can be automatically adjusted based on the detected age of the user, the pupil diameter of the user, the ambient light surrounding the user or on the user's face, the distance between the user and the display, or any logical combination of all the preceding conditions.

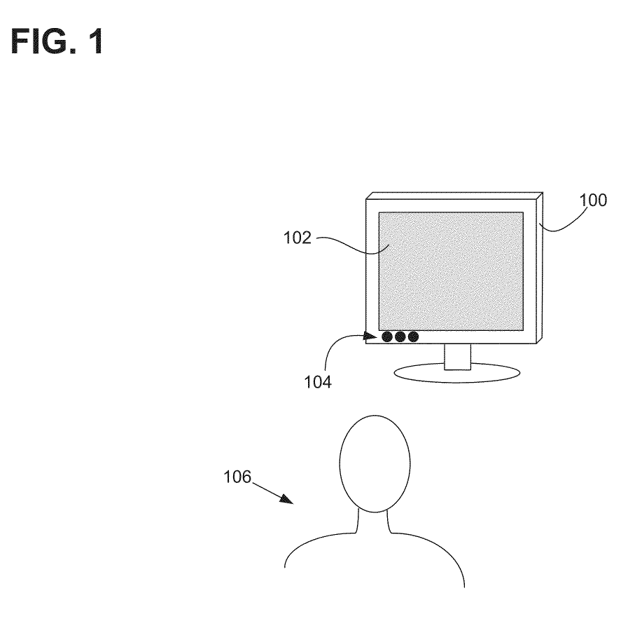

FIG. 1 illustrates a display 100, such as a computer monitor, a television display, a cellular telephone display, a tablet display, or a laptop computer display, having a screen 102 and a plurality of sensors 104. The sensors can include, for example, an imaging sensor such as a camera including a CCD or CMOS sensor, a flash or other form of illumination, and/or any other sensor configured to detect or image objects, such as ultrasound, infrared (IR), heat sensors, or ambient light sensors. The sensors can be disposed on or integrated within the display, or alternatively, the sensors can be separate from the display. Any number of sensors can be included in the display. In some embodiments, combinations of sensors can be used. For example, a camera, a flash, and an infrared sensor can all be included in a display in one embodiment. It should be understood that any combination or number of sensors can be included on or near the display. As shown in FIG. 1, user 106 is shown positioned before the display 100, within detection range or field of view of the sensors 104.

Various embodiments involve a camera mounted on or near a display coupled with a processor programmed to detect, track and/or recognize a face or partial face, or a face region, such as one or two eyes, or a mouth region, or a facial expression or gesture such as smiling or blinking. In some embodiments, the processor is integrated within or disposed on the display. In other embodiments, the processor is separate from the display. The processor can include memory and software configured to receive signals from the sensors and process the signals. Certain embodiments include sensing a user or features of a user with the sensors and determining parameters relating to the face based such as orientation, pose, tilt, tone, color balance, white balance, relative or overall exposure, face size or face region size including size of eyes or eye regions such as the pupil, iris, sclera or eye lid, a focus condition, and/or a distance between the camera or display and the face. In this regard, the following are hereby incorporated by reference as disclosing alternative embodiments and features that may be combined with embodiments or features of embodiments described herein: U.S. patent application Ser. Nos. 13/035,907, filed Feb. 25, 2011, 12/883,183, filed Sep. 16, 2010 and 12/944,701, filed Nov. 11, 2010, each by the same assignee, and U.S. Pat. Nos. 7,853,043, 7,844,135, 7,715,597, 7,620,218, 7,587,068, 7,565,030, 7,564,994, 7,558,408, 7,555,148, 7,551,755, 7,460,695, 7,460,694, 7,403,643, 7,317,815, 7,315,631, and 7,269,292.

Many techniques can be used to determine the age of a user seated in front of a display or monitor. In one embodiment, the age of the user can be determined based on the size of the user's eye, the size of the user's iris, and/or the size of the user's pupil.

Depending on the sensors included in the display, an image or other data on the user can be acquired by the display with the sensors, e.g., an image of the user. Meta-data on the acquired date, including the distance to the user or object, the aperture, CCD or CMOS size, focal length of the lens and the depth of field, can be recorded on or with the image at acquisition. Based on this information, the display can determine a range of potential sizes of the eye, the iris, the pupil, or red eye regions (if a flash is used).

The variability in this case is not only for different individuals, but also variability based on age. Luckily, in the case of eyes, the size of the eye is relatively constant as a person grows from a baby into an adult. This is the reason of the striking effect of “big eyes” that is seen in babies and young children. The average infant's eyeball measures approximately 19.5 millimeters from front to back, and as described above, grows to 24 millimeters on average during the person's lifetime. Based on this data, in the case of eye detection, the size of an object in the field of view which could be a pupil (which is part of the iris), is limited, allowing some variability to be:

9 mm≦Size Of Iris≦13 mm

As such, by detecting or determining the size of the eye of a user relative to other facial features with sensors 104, the age of the user can be calculated. Further details on the methods and processes for determining the age of a user based on eye, iris, or pupil size can be found in U.S. Pat. No. 7,630,006 to DeLuca et al.

In another embodiment, human faces may be detected and classified according to the age of the subjects (see, e.g., U.S. Pat. No. 5,781,650 to Lobo et al.). A number of image processing techniques may be combined with anthropometric data on facial features to determine an estimate of the age category of a particular facial image. In a preferred embodiment, the facial features and/or eye regions are validated using anthropometric data within a digital image. The reverse approach may also be employed and may involve a probability inference, also known as Bayesian Statistics.

In addition to determining the age of the user, the display can also determine or detect the distance of the user to the display, the gaze, or more specifically, the location and direction upon which the user is looking, the posture or amount of head tilt of the user, and lighting levels including ambient light and the amount of brightness on the user's face. Details on how to determine the distance of the user from the display, the gaze of the user, the head tilt or direction, and lighting levels are also found in U.S. Pat. No. 7,630,006 to DeLuca et al, and U.S. application Ser. No. 13/035,907.

Distance can be easily determined with the use of an IR sensor or ultrasound sensor. In other embodiments, an image of the user can be taken with a camera, and the distance of the user can be determined by comparing the relative size of the detected face to the size of detected features on the face, such as the eyes, the nose, the lips, etc. In another embodiment, the relative spacing of features on the face can be compared to the detected size of the face to determine the distance of the user from the sensors. In yet another embodiment, the focal length of the camera can be used to determine the distance of the user from the display, or alternatively the focal length can be combined with detected features such as the size of the face or the relative size of facial features on the user to determine the distance of the user from the display.

In some embodiments, determining the gaze of the user can include acquiring and detecting a digital image including at least part of a face including one or both eyes. At least one of the eyes can be analyzed, and a degree of coverage of an eye ball by an eye lid can be determined. Based on the determined degree of coverage of the eye ball by the eye lid, an approximate direction of vertical eye gaze can be determined. The analysis of at least one of the eyes may further include determining an approximate direction of horizontal gaze. In some embodiments, the technique includes initiating a further action or initiating a different action, or both, based at least in part on the determined approximate direction of horizontal gaze. The analyzing of the eye or eyes may include spectrally analyzing a reflection of light from the eye or eyes. This can include analyzing an amount of sclera visible on at least one side of the iris. In other embodiments, this can include calculating a ratio of the amounts of sclera visible on opposing sides of the iris.

In some embodiments, the digital image can be analyzed to determine an angular offset of the face from normal, and determining the approximate direction of vertical eye gaze based in part on angular offset and in part on the degree of coverage of the eye ball by the eye lid.

Some embodiments include extracting one or more pertinent features of the face, which are usually highly detectable. Such objects may include the eyes and the lips, or the nose, eye brows, eye lids, features of the eye such as pupils, iris, and/or sclera, hair, forehead, chin, ears, etc. The combination of two eyes and the center of the lips, for example can create a triangle which can be detected not only to determine the orientation (e.g., head tilt) of the face but also the rotation of the face relative to a facial shot. The orientation of detectible features can be used to determine an angular offset of the face from normal. Other highly detectible portions of the image can be labeled such as the nostrils, eyebrows, hair line, nose bridge, and neck as the physical extension of the face.

Ambient light can be determined with an ambient light sensor, or a camera. In other embodiments, ambient light can be determined based on the relative size of a user's pupils to the size of their eyes or other facial features.

With these settings or parameters detected by the display, including age, eye, pupil, and iris size, distance from the display, gaze, head tilt, and/or ambient lighting, any number of user preference settings can be dynamically adjusted or changed to accommodate the specific user and setting.

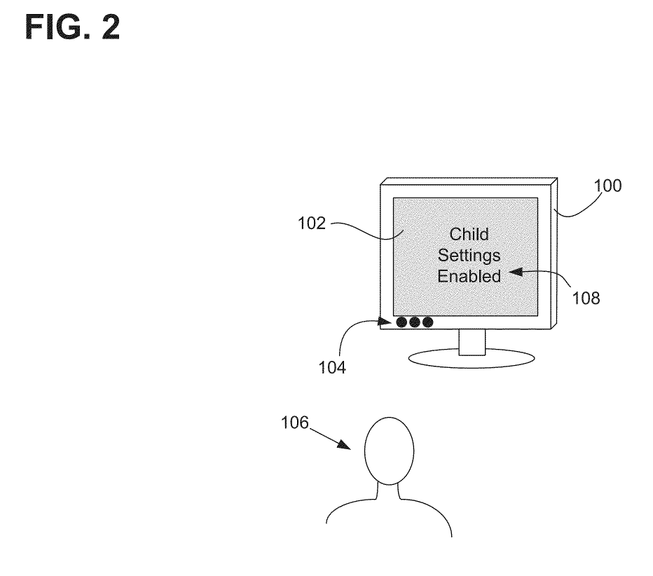

In one embodiment, displayable content and privacy settings can be automatically changed based on a detected age of the user. Referring to FIG. 2, upon detection of a child or young adult in front of the display 100, a prompt or symbol 108 can be displayed to indicate that a child or young adult has been detected and the appropriate displayable content and privacy settings have been enabled for display. In one embodiment, if a child or young adult is detected in front of the display, pre-set privacy and filtering options (i.e., programmed or chosen by an adult or administrator) can be enabled to control the type of content shown on display 100. For example, web-browser filtering can be strengthened to prevent a young user from encountering material or content deemed by a parent or administrator to be age inappropriate (e.g., pornography, foul language, violence, etc).

Determination of what age groups constitute a “child”, a “young adult”, and “adult”, or an “elderly” person can be pre-programmed or chosen by an administrator. In some embodiments, however, a child can be a person under the age of 15, a young adult can be a person from ages 15-17, an adult can be a person from ages 18-65, and an elderly person can be a person older than age 65.

Additionally, content already contained upon a computer attached to the display can be deemed non-displayable depending on the age or class of user detected. For example, private financial files, photographs, videos, or other sensitive documents or data can automatically become inaccessible or non-displayable if the user before the display is determined to be too young. As described above, the age limit cutoff for determining if data is inaccessible or non-displayable can be pre-programmed or chosen by an administrator.

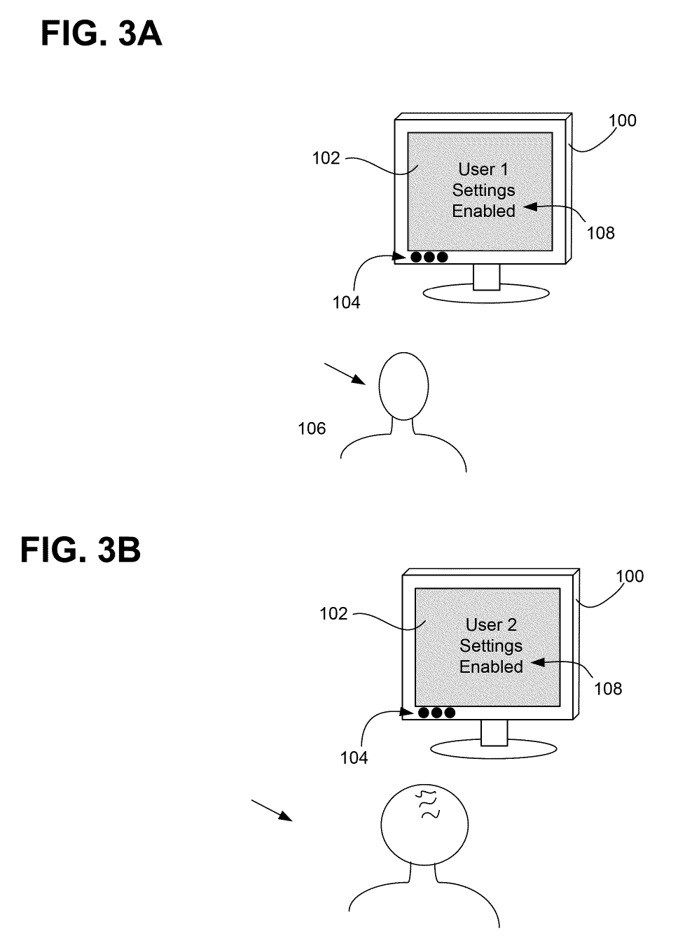

In addition to changing displayable content and/or privacy settings based on the detected age of the user, in some embodiments the display can detect or recognize specific individual users and adjust the displayable content, privacy settings, and/or personal settings based on the individual user detected. Referring to FIG. 3A, a first user (e.g., User 1) is recognized by the display and that user's individual user preferences, displayable content, and privacy settings are automatically loaded on the display as indicated by prompt 108. Similarly, in FIG. 3B, a second user (e.g., User 2) is recognized by the display and that user's individual user preferences, displayable content, and privacy settings are automatically loaded on the display as indicated by prompt 108. Since these settings can be customized, either by the user or by someone else (e.g., a parent or administrator), it should be understood that User 1's settings may be different than the settings of User 2. For example, an administrator can change the user displayable content and privacy settings for all potential users of the system, and can input photos of each user or other recognizable features for each potential user. When the users are positioned before the display, the display can take an image of the user and compare it to the known users of the system, and automatically adjust the displayable content and privacy settings based on the detected user.

In another embodiment, the display can detect the presence of a user positioned before the display for a predetermined time limit, and indicate to the user with a prompt or symbol 108 that the user has exceeded the predetermined time limit in front of the display. This can be used, for example, to limit the amount of time a user spends in front of the display, or to encourage frequent breaks (e.g., for exercise, to reduce eye strain, etc). In some embodiments, the predetermined time limit can be varied depending on the age of the user detected by the display. For example, a parent may wish to limit the amount of time a child spends in front of the display. In this example, if the display detects the user to be a child, then after the predetermined time limit the indicator or symbol can be displayed to encourage the user to stop using the display. In another embodiment, a user timer indicator or symbol 110 can encourage the user to take a short break, such as to comply with local, state, or federal rules requiring employee breaks after a certain amount of time. In some embodiments, the display can be automatically turned off after reaching the predetermined time limit. Additionally, the display can remain off for programmed duration to prevent further use (e.g., until the next day, or until a pre-set period of time has passed before the display can be used again).

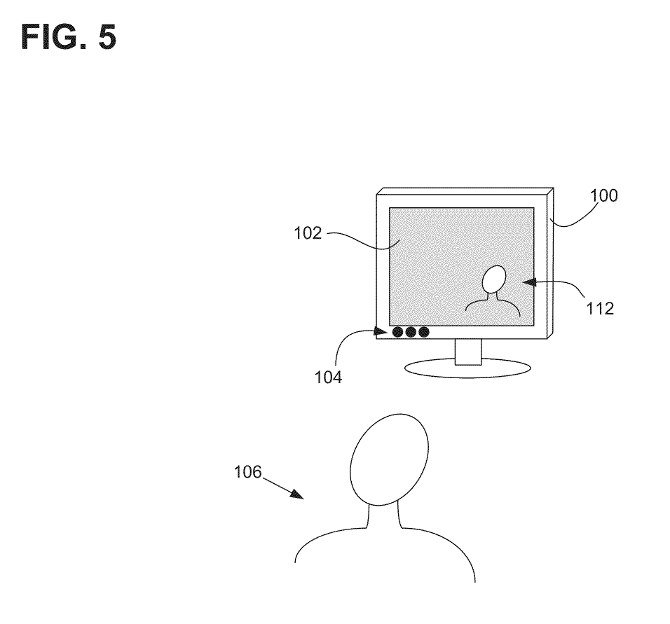

In addition to determining whether a user has exceeded a predetermined time limit in front of the display, the display can also determine if the user is sitting improperly or tilting his or her head in a way that may lead to injury or discomfort. For example, referring to FIG. 5, the display may detect or determine that the user 106 is gazing at the display with poor posture or with a tilted head, which may potentially lead to pain, cramps, or other discomfort. An improper head tilt can be determined to be an angular tilting of the head offset from a normal or vertical head posture. In this instance, the display can show an ergonomic indicator or symbol 112 to notify or indicate to the user to correct his or her improper posture or head tilt. This feature may be able to correct improper posture or head tilt in an otherwise unaware user, preventing future pain, discomfort, or injuries.

The face detection, eye detection, distance, and age determinations described above can further be used in combination with light detection (e.g., ambient light detection or illumination level of the face of the user) for changing or adjusting additional user preference settings. In one embodiment, display brightness can be changed based on the amount of ambient light detected by the display. Furthermore, it may be determined that an older user requires a brighter screen than a younger user, so brightness of the screen can be automatically adjusted depending on the detected age of the user. In another embodiment, the ambient light is detected based on a detected brightness of the face. In yet another embodiment, the display can detect a pupil closure percentage and combine it with an illumination level on the face and/or the background ambient light level to determine the brightness level of the screen.

For example, if a light is shining in a user's face, then the user's pupils will be more closed and he or she will need a brighter screen. In this example, the screen can be automatically brightened based on the illumination level of the user's face and/or the size of the user's pupils. On the other hand, if there is high ambient light in the background of the user, but not in the user's face, then the user's pupils will be more open, yet the screen may be adequately lit already by the background light and no adjustments may need to be made. In yet another scenario, both the face of the user and the background of the user are dark or have low ambient light, then a bright screen may again be needed and the brightness of the display can be automatically increased or adjusted to compensate.

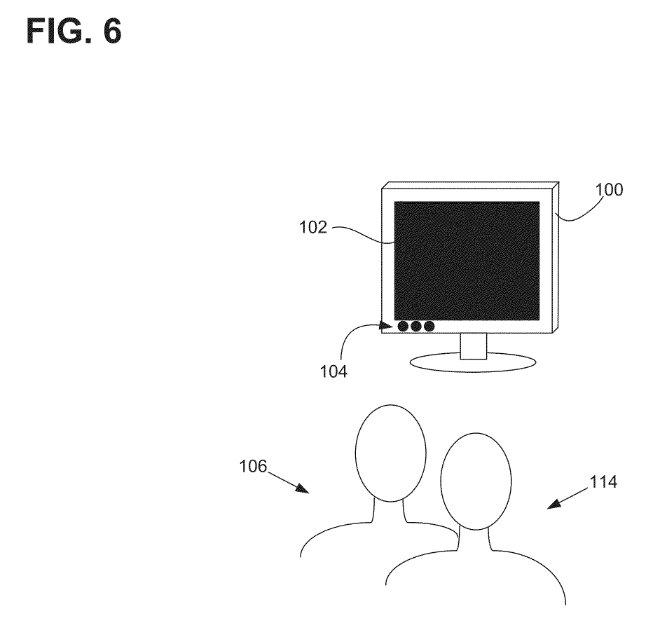

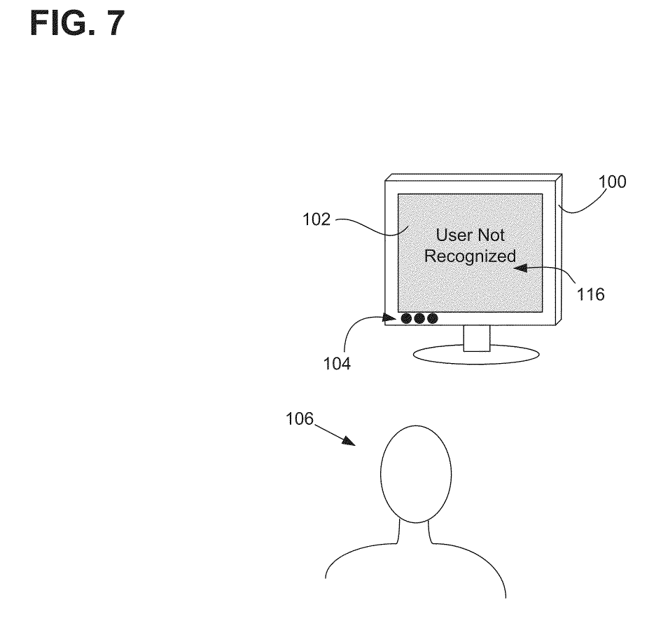

In yet another embodiment, user or screen privacy can be adjusted when an additional person enters the field of view of the sensors, or when an unrecognized user enters the field of view. In the first embodiment, as shown in FIG. 6, the screen 102 of the display 100 can be turned off when a second user 114 enters the field of view along with user 106. Similarly, referring to FIG. 7, if a user 106 is not recognized by the display, an indicator or symbol 116 can be displayed on the display to indicate to the user that he or she is not recognized. In this embodiment, the display can be programmed to automatically shut off after displaying the indicator 116, or alternatively, can display a lock screen until a recognized user enters the field of view or until the unknown user 106 is given access to the system.

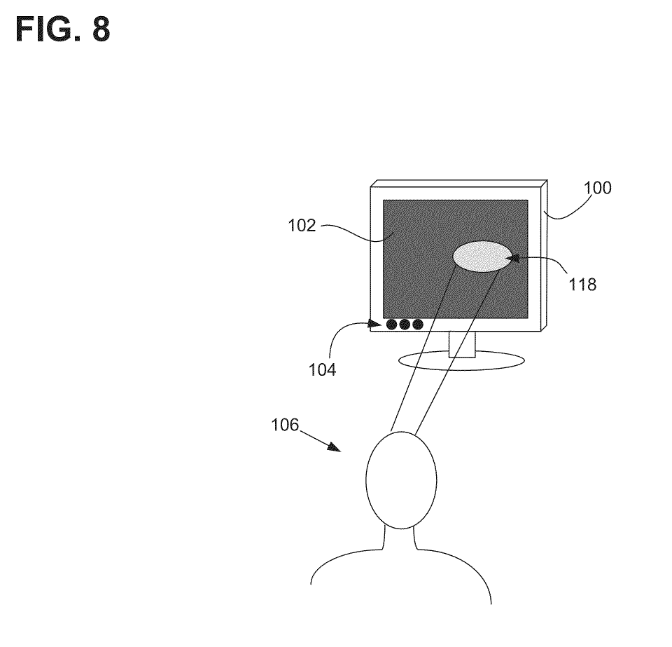

In yet an additional embodiment, the display can follow the user's gaze and illuminate only the section 118 of the screen that corresponds to the user's gaze, as shown in FIG. 8. The display can also self-calibrate itself based on a user's eye movement across the screen while reading multiple lines of text and illuminate the appropriate sections of the screen based on the user's reading speed.

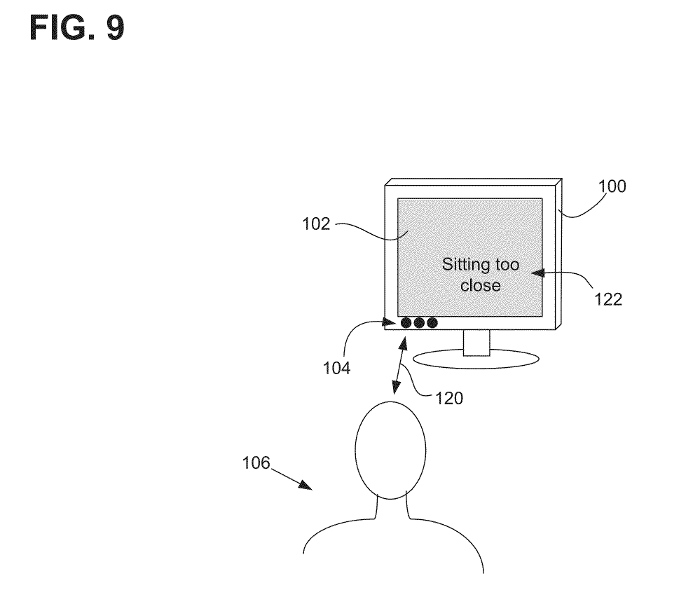

In yet another embodiment, shown in FIG. 9, the display 100 can indicate to a user 106 with indicator or icon 122 when the user is sitting too close to the display (i.e., when the display detects that the user is positioned closer to the display than an optimal viewing distance).

In some embodiments, the display can automatically adjust the brightness of the display or turn on/off the display completely to save power based on the detected user settings.

The system can also include features for power saving based on the user detected features described above. The power saving process can include multiple steps. For example, if the display does not recognize a face and/or both eyes in front of the display for a predetermined period of time, the display can initiate a power savings protocol. In one embodiment, a first level of power saving can be initiated. For example, a first level of power savings can be to dim the display by a set percentage when a user is not detected in front of the display for the predetermined period of time. If the display continues to not detect the user's face and/or eyes for an additional period of time, the display can be powered down completely. This process can have multiple intermediate power level steps that are configurable by an administrator of the system based on individual power savings goals.

In another embodiment, the entire sensor system and processor of the display system can be turned off with the display when it enters a power savings mode. The sensors and processor can be configured to turn on once in a while (e.g., to turn on briefly after a predetermined period of time has lapsed), scan for a face and/or eyes, and turn back off if a user and/or eyes are not detected. This can be a very useful in a software only implementation where the software is running on a power hungry processor.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

What is claimed is:

1. A method of dynamically changing a display parameter, comprising:
detecting a user parameter of a user positioned before an electronic display; and
automatically adjusting a user preference on the display or displaying an indicator based on the detected user parameter.

2. The method of claim 1 wherein the user parameter is an age of the user.

3. The method of claim 2 wherein an amount of displayable content is increased when the user is elderly.

4. The method of claim 2 wherein an amount of displayable content is decreased when the user is a child or young adult.

5. The method of claim 2 wherein privacy settings are increased when the user is a child or young adult.

6. The method of claim 2 wherein privacy settings are decreased when the user is an adult or elderly.

7. The method of claim 1 wherein the user parameter is a distance from the user to the electronic display.

8. The method of claim 7 wherein a distance indicator is displayed when the distance is less than an optimal distance.

9. The method of claim 1 wherein the user parameter is a time the user has been positioned before the display.

10. The method of claim 9 wherein a time indicator is displayed when the time is greater than a predetermined time limit.

11. The method of claim 1 wherein the user parameter is a head angle.

12. The method of claim 11 wherein an ergonomic indicator is displayed when the head angle is improper.

13. The method of claim 1 wherein the user parameter is an ambient light level.

14. The method of claim 1 wherein the user parameter is an ambient light level and a pupil closure percentage.

15. The method of claim 14, wherein if the ambient light level is low, and the pupil closure percentage is high, the display is automatically brightened.

16. The method of claim 14, wherein if the ambient light level is low, and the pupil closure percentage is low, the display is automatically dimmed.

17. The method of claim 14, wherein if the ambient light level is high, and the pupil closure percentage is high, the display is automatically brightened.

18. The method of claim 14, wherein if the ambient light level is high, and the pupil closure percentage is low, the display is automatically dimmed.

19. The method of claim 13 wherein the display is automatically dimmed or brightened based on the detected ambient light level.

20. The method of claim 1 wherein the user parameter is an unknown user.

21. The method of claim 20 wherein the display is dimmed or turned off when the unknown user is detected.

22. The method of claim 20 wherein the display is locked and a security indicator is shown on the display when the unknown user is detected.

23. The method of claim 22 wherein the security indicator notifies the unknown user that access to the display is denied.

24. The method of claim 1 wherein the detecting step comprises detecting the user parameter with a sensor disposed on or near the electronic display.

25. The method of claim 24 wherein the sensor comprises a camera.

26. The method of claim 1 wherein the electronic display comprises a computer monitor.

27. The method of claim 1 wherein the electronic display comprises a cellular telephone.

28. The method of claim 1 wherein the automatically adjusting step comprises processing the user parameter with a controller and automatically adjusting the user preference on the display or displaying the indicator based on the detected user parameter.

29. An electronic display, comprising:
sensors configured to detect a user parameter of a user positioned before the display;
a screen configured to display text or images to the user; and
a processor configured to adjust a user preference or display an indicator based on the detected user parameter.

30. The electronic display of claim 29 wherein the user parameter is age.

31. The electronic display of claim 29 wherein the user parameter is a distance from the user to the electronic display.

32. The electronic display of claim 29 wherein the user parameter is a head angle of the user.

33. The electronic display of claim 29 wherein the user parameter is an unknown user.

34. The electronic display of claim 29 wherein the user parameter is an ambient light level.

35. The electronic display of claim 29 wherein the sensor comprises a camera.

36. The electronic display of claim 29 wherein the electronic display comprises a computer monitor.

37. The electronic display of claim 29 wherein the electronic display comprises a cellular telephone.

38. The electronic display of claim 29 wherein the electronic display comprises a tablet computer.

39. A method of dynamically adjusting a display parameter, comprising:
determining with a sensor whether a user's face is positioned before an electronic display;
if the user's face is not positioned before the electronic display, monitoring for the user's face with the sensor for a predetermined period of time; and
initiating a power savings routine on the electronic display if the user's face is not positioned before the electronic display during the predetermined period of time.

40. The method of claim 39, wherein the power savings routine comprises dimming the display.

41. The method of claim 39, wherein the power savings routine comprises powering off the display.

42. The method of claim 41 further comprising, after powering off the display, occasionally powering on the sensor of the electronic display to monitor for the user's anatomy.

43. The method of claim 39, further comprising:
determining with the sensor if the user's eyes are gazing towards the electronic display;
if the user's eyes are not gazing towards the electronic display, monitoring with the sensor for the user's eyes to gaze towards the display during the predetermined period of time; and
initiating the power savings routine on the electronic display if the user's eyes do not gaze towards the electronic display during the predetermined period of time.

44. The method of claim 39 wherein the predetermined period of time is user adjustable.

45. The method of claim 40 wherein a dimming percentage is user adjustable.

46. An electronic display, comprising:
a sensor configured to detect a user's face positioned before the display; and
a processor configured to implement a power savings routine if the user's face is not positioned before the display during a predetermined period of time.

47. The electronic display of claim 46 wherein the sensor comprises a camera.

48. The electronic display of claim 46 wherein the electronic display comprises a computer monitor.

49. The electronic display of claim 46 wherein the electronic display comprises a cellular telephone.
